(19) United States
(12) Patent Application Publication
(10) Pub. No.: US 2025/0254058 A1
(43) Pub. Date: Aug. 7, 2025

(54) PHYSICAL SPACE RECOMMENDATIONS TO OPTIMIZE USER APPLICATION QUALITY OF EXPERIENCE IN OFFICE ENVIRONMENTS

(71) Applicant: Cisco Technology, Inc., San Jose, CA (US)

(72) Inventors: Eduard Schornig, Haarlem (NL); Pierre-André Savalle, Rueil-Malmaison (FR); Grégory Mermoud, Venthône (CH); Jean-Philippe Vasseur, Combloux (FR)

(73) Assignee: Cisco Technology, Inc., San Jose, CA (US)

(21) Appl. No.: 18/435,688

(22) Filed: Feb. 7, 2024

(51) Int. Cl. H04L 12/18; H04L 65/80

(52) U.S. Cl. CPC H04L 12/1827; H04L 12/1818; H04L 65/80

(57) ABSTRACT

In one embodiment, a device obtains network telemetry and environmental telemetry associated with a physical environment. The device forecasts, based on the network telemetry and environmental telemetry, future values of the network telemetry and environmental telemetry. The device predicts, based on the future values, quality of experience metrics for an online application for different locations within the physical environment. The device provides, based on the quality of experience metrics, a recommendation to a user interface that recommends a user of the online application navigate to a particular location from among the different locations to access the online application at a future point in time.

### TECHNICAL FIELD

The present disclosure relates generally to computer networks, and, more particularly, to physical space recommendations to optimize user application quality of experience (QoE) in office environments.

### BACKGROUND

With the recent evolution of machine learning, predictive failure detection and proactive routing in a network now becomes possible through the use of machine learning techniques. For instance, modeling the delay, jitter, packet loss, etc. for a network path can be used to predict when that path will violate the service level agreement (SLA) of the application and reroute the traffic, in advance. However, doing so is also not without cost, as needlessly rerouting application traffic can also negatively impact the application experience of a user.

Traditionally, SLA thresholds have been used as a proxy for the true quality of experience (QoE) of an online application from the perspective of the end user. In other words, it is assumed that if the SLA is being violated, the QoE of the application is also degraded. While this may hold true in clear situation of network impairment, some of the more complex types of impairments could go unnoticed by network systems.

Beyond simply assessing the network paths, office environments also present unique challenges with respect to predicting the QoE of an application, as environmental factors and other characteristics of a physical space can often affect the connection of an endpoint client to an online application. Indeed, even something as simple as the location of an endpoint client relative to a wireless access point can have an impact on the application QoE.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example office environment;

FIG. 6 illustrates an example architecture for providing physical space recommendations to optimize user application quality of experience (QoE) in office environments; and

FIG. 7 illustrates an example simplified procedure for providing physical space recommendations to optimize user application QoE in office environments.

### DESCRIPTION OF EXAMPLE EMBODIMENTS

### Overview

According to one or more embodiments of the disclosure, a device obtains network telemetry and environmental telemetry associated with a physical environment. The device forecasts, based on the network telemetry and environmental telemetry, future values of the network telemetry and environmental telemetry. The device predicts, based on the future values, quality of experience metrics for an online application for different locations within the physical environment. The device provides, based on the quality of experience metrics, a recommendation to a user interface that recommends a user of the online application navigate to a particular location from among the different locations to access the online application at a future point in time.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

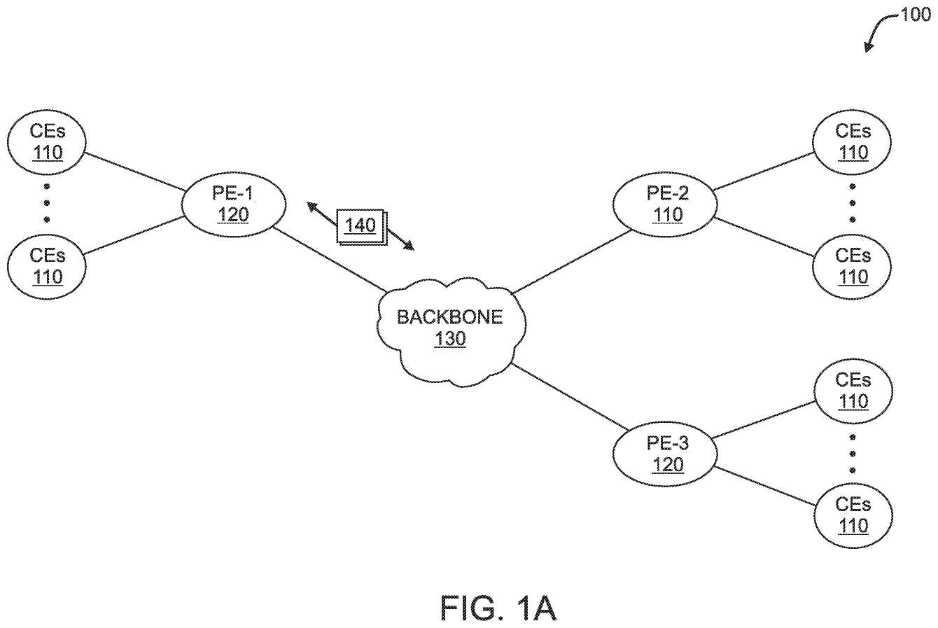

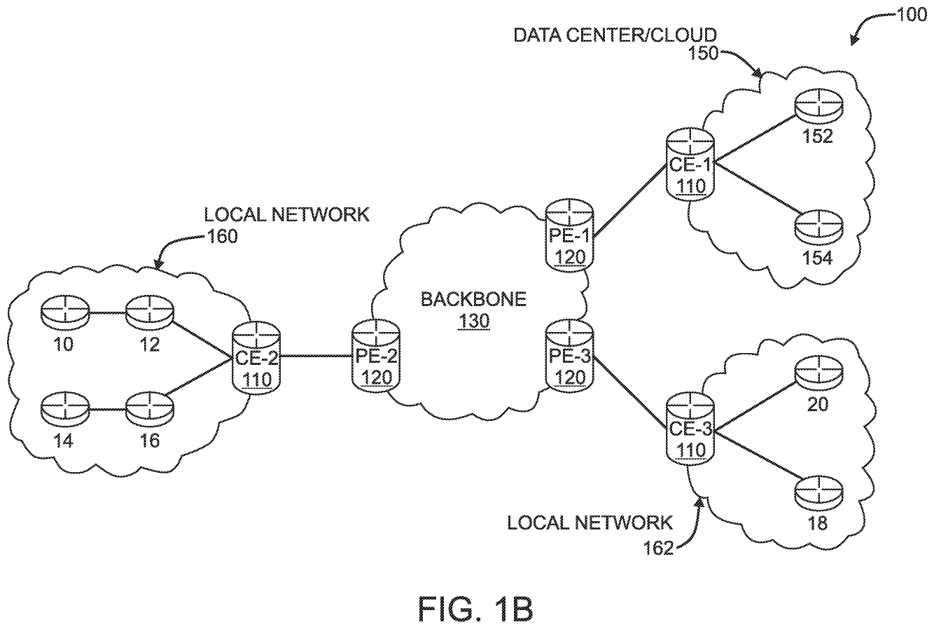

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

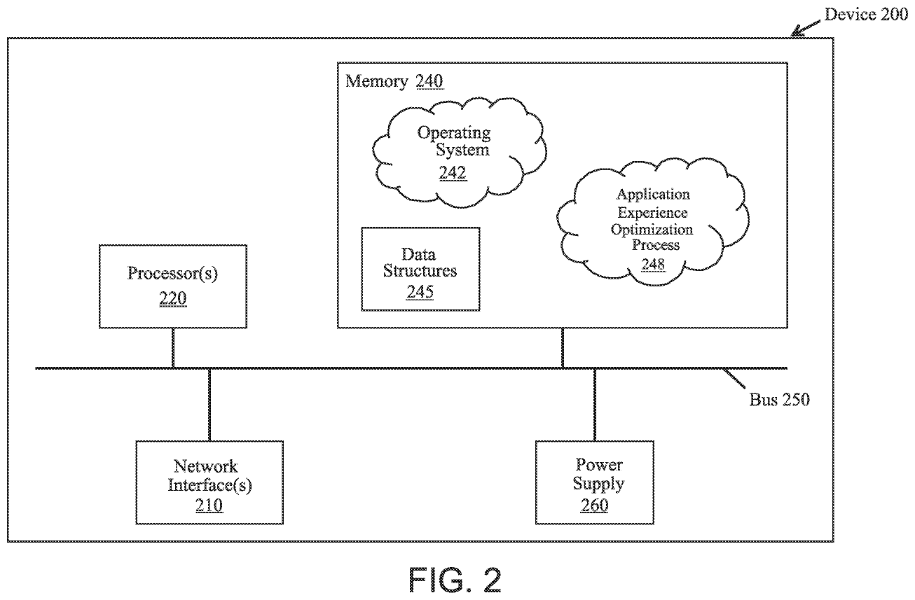

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an application experience optimization process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, application experience optimization process 248 may include computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, application experience optimization process 248 may consist solely of providing mechanisms necessary for source routing techniques. That is, for source routing, other devices in the network can tell the less capable devices exactly where to send the packets, and the less capable devices simply forward the packets as directed.

In various embodiments, as detailed further below, application experience optimization process 248 may include computer executable instructions that, when executed by processor(s) 220, cause device 200 to perform the techniques described herein. To do so, in some embodiments, application experience optimization process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, application experience optimization process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that application experience optimization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, application experience optimization process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, videofimages, text, etc.), based on an existing body of training data. For instance, in the context of network assurance, application experience optimization process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

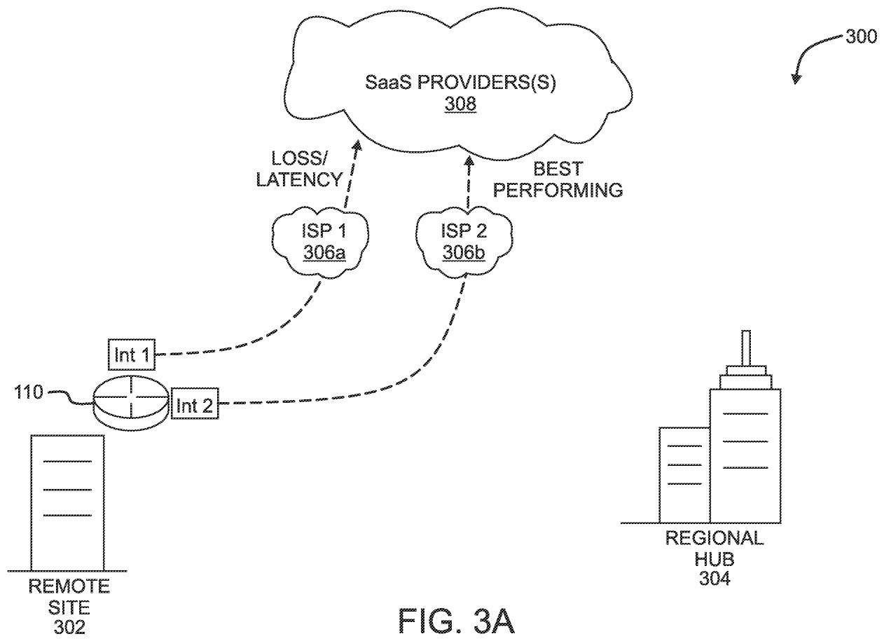

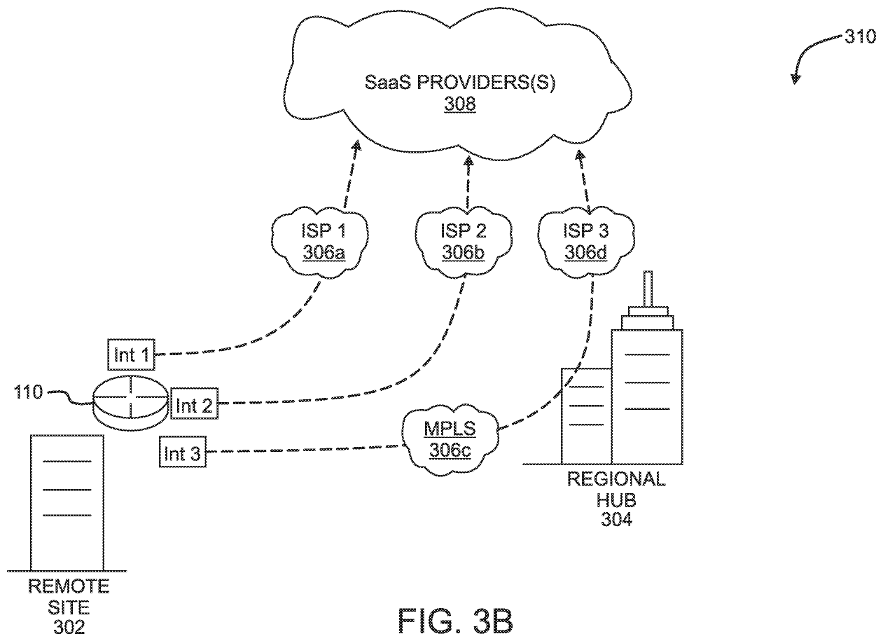

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

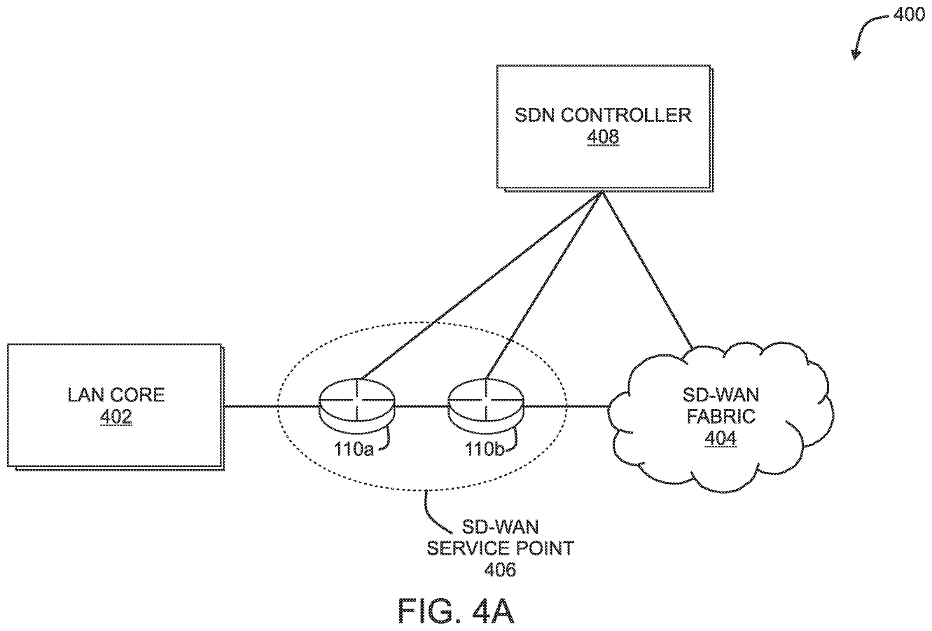

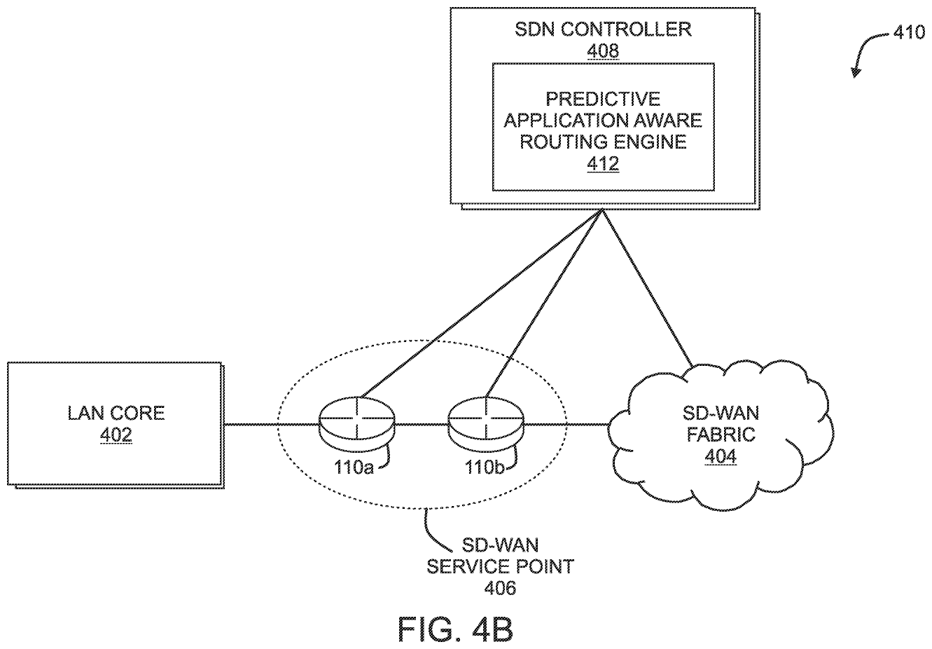

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. Domain Name System (DNS) resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of application experience optimization process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In other words, predictive application aware routing engine 412 may use SLA violations as a proxy for actual QoE information (e.g., ratings by users of an online application regarding their perception of the application), unless such QoE information is available from the provider of the online application. In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

As noted above, enterprise networks have undergone a fundamental transformation whereby users and applications have become increasingly distributed whereby technologies such as SD-WAN, Hybrid Work, and Zero Trust Network Access (ZTNA) have enabled unprecedented flexibility in terms of network architecture and underlay connectivity options. At the same time, collaboration applications, which are often critical for day-to-day business operations, have moved from on-premises deployment to a SaaS cloud delivery model that allows application vendors to rapidly deploy and take advantage of the latest and greatest codecs that can be used to increase robustness of media content.

In this highly dynamic environment, the ability of network administrators to understand the impact of network performance (or lack of) on the QoE of online applications, as well as ensuring that the proper SLAs are satisfied, is becoming increasingly challenging. Indeed, in years past, network metrics were used as a proxy for the true application QoE, with SLAs being set, accordingly. For instance, in the case of a voice application, the usual SLA boundaries are 150 ms for delay, 50 ms for jitter, and maximum of 3% packet loss. Today, such values are not as clear-cut. For example, two real-time voice calls may have different loss thresholds based on the audio codec being used whereby a voice application that uses a lossy codec such as Opus may be resistant until a packet loss of up to 30%, whereas other audio codecs, such as advanced audio coding (AAC), are usually not resilient to such high loss thresholds.

Another factor that demonstrates the shortfalls of relying on SLA thresholds as a proxy for the true application QoE is that SLAs are set without any consideration to the granularity of their underlying measurements. For instance, a path experiencing a constant delay of 120 ms for voice over a period of 10 minutes provides a very different user experience than a path with the same average delay that keeps varying between 20 and 450 ms, despite averaging out to the same over the time period. The dynamics of such metrics is even more critical for packet loss and jitter in the case of voice and video traffic (e.g. ten seconds of 80% packet loss would severely impact the user experience although averaged out over ten minutes would give a low value totally acceptable according to the threshold). Without a doubt, the user experience requires a more subtle and accurate approach in order to determine the networking requirements a path should meet in order to maximize the user satisfaction, capturing local phenomenon (e.g. effects on delay, jitter and loss at higher frequencies) but also telemetry from upper layers (applications).

Traditionally, a core principle of the Internet has been layer isolation. Such an approach allowed layer dependency (e.g. often referred to as layer violation) to be avoided, at a time where a number of protocols and technologies were developed at each layer. More specifically, the Open Systems Interconnection (OSI) model divides networks into seven networking layers:
1. The Physical (PHY) Layer—the layer representing the physical connections between devices
2. The Data Link Layer—e.g., the layer at which MAC addressing is used
3. The Network Layer—e.g., the layer at which the IP protocol is used
4. The Transport Layer—e.g., the layer at which TCP or UDP
5. The Session Layer—e.g., the layer at which a given session between endpoints is managed
6. The Presentation Layer—e.g., the layer that translates requests from the application layer to the session layer and vice-versa
7. The Application Layer—e.g., the highest layer at which the application itself operates

This allowed for the design and deployment of new layers (e.g. PHY, MAC, etc.) independent of each other, and allowing the Internet to scale. Still, with modern applications requiring tight SLAs, a cross-layer approach would be highly beneficial to optimizing the QoE of any given online application.

Further, even with a mechanism that is able to accurately estimate the application experience from the perspective of a user, another challenge still exists with respect to selecting the appropriate network action to improve the experience. Indeed, although the effect of specific actions at a given layer of the networking stack on user experience can be qualitatively evaluated, being able to precisely quantify it is often unknown. For instance, determining that voice quality is low along a highly congested path may be relatively easy. However, determining the correct amount of bandwidth to allocate to the path or the appropriate queue weight for the traffic of the application still remains quite challenging.

According to various embodiments, application experience optimization process 248 may leverage the concept of cognitive networking. Instead of taking a siloed approach where networking systems poorly understand user satisfaction, cognitive networks are fully driven by understanding user experience (cognition) using cross-layer telemetry and ground truth user feedback, in order to determine which networking actions can optimize the user experience. To that end, a rich set of telemetry sources are gathered along with labeled user feedback in order to train a machine learning model to predict/forecast the user experience (i.e., the QoE of an online application). Such a holistic approach that is end-to-end across the different network layers is a paradigm shift to how networks have been designed and operated since the early days of the Internet.

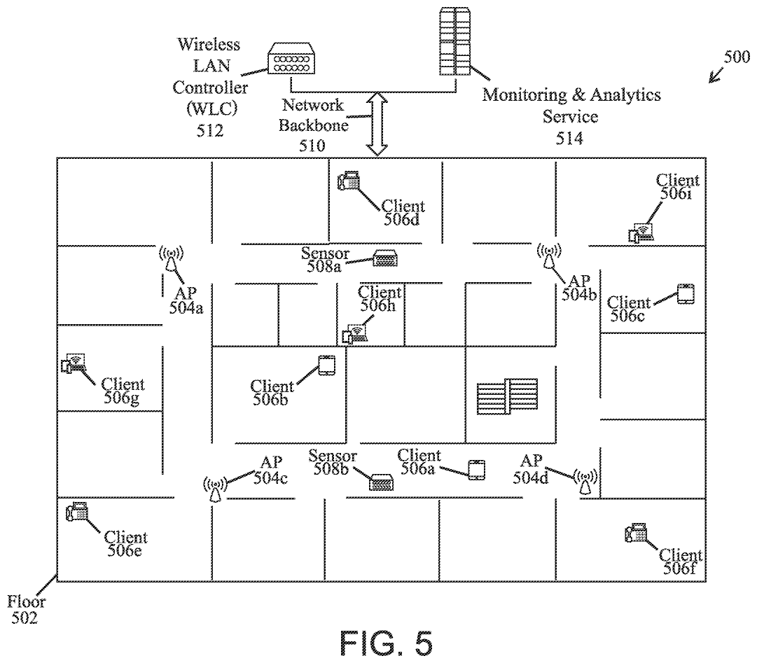

FIG. 5 illustrates an example office environment 500, according to various embodiments. Office environment 500 may include any number of physical locations, such as floor 502 shown, and may include various infrastructure devices. These infrastructure devices may include, for example, one or more access points (APs) 504 that provide wireless connectivity to the various wireless clients 506 distributed throughout the location. For illustrative purposes, APs 504a-504d and clients 506a-506i are depicted in FIG. 5. However, as would be appreciated, a wireless network deployment may include any number of APs and clients.

A network backbone 510 may interconnect APs 504a-504d and provide a connection between APs 504a-504d and any number of supervisory devices or services that provide control over APs 504a-504d. For example, as shown, a wireless LAN controller (WLC) 512 may control some or all of APs 504a-504d, by setting their control parameters (e.g., max number of attached clients, channels used, wireless modes, etc.). Another supervisory service that oversees the wireless network in office environment 500 may be a monitoring and analytics service 514 that measures and monitors the performance of the wireless network in office environment 500 and, if so configured, may also adjust the operation of the wireless network based on the monitored performance (e.g., via WLC 512, etc.).

Network backbone 510 may further provide connectivity between the infrastructure of the local network and a larger network, such as the Internet, a Multiprotocol Label Switching (MPLS) network, or the like. Accordingly, WLC 512 and/or monitoring and analytics service 514 may be located on the same local network as APs 504 or, alternatively, may be located remotely, such as in a remote datacenter, in the cloud, etc. To provide such connectivity, network backbone 510 may include any number of wired connections (e.g., Ethernet, optical, etc.) and/or wireless connections (e.g., cellular, etc.), as well as any number of networking devices (e.g., routers, switches, etc.).

In some embodiments, the wireless network in office environment 500 may also include any number of wireless network sensors 508, such as sensors 508a-508b shown. In general, “wireless network sensors” are specialized devices that are able to act as wireless clients and perform testing on the wireless network in office environment 500 and are not to be confused with other forms of sensors that may be distributed throughout a wireless network, such as motion sensors, temperature sensors, etc. In some cases, any of APs 504a-504d can also act as a wireless network sensor, by emulating a client in the network for purposes of testing communications with other APs. Thus, emulation points in the wireless network may include dedicated wireless network sensors 508 and/or APs 504, if so configured.

During operation, the purpose of an emulation point in the wireless network is to act as a wireless client and perform tests that include connectivity, performance, and/or negative scenarios, and report back on the network behavior to monitoring and analytics service 514. In turn, service 514 may perform analytics on the obtained performance metrics, to identify potential network issues before they are reported by actual clients. If such an issue is identified, service 514 can then take corrective measures, such as changing the operation of the wireless network and/or reporting the potential issue to a network administrator or technician.

In further implementations, sensors 508a-508b may take the form of one or more IoT sensors that measure physical conditions within office environment 500. For instance, example sensors that may be present within office environment 500 may include, but are not limited to, occupancy sensors, cameras, temperature sensors, humidity sensors, motion sensors, noise sensors, or the like.

The types and configurations of clients 506 in the network in office environment 500 can vary greatly. For example, clients 506a-506c may be mobile phones, clients 506d-506f may be office phones, and clients 506g-506i may be computers, all of which may be of different makes, models, and/or configurations (e.g., firmware or software versions, chipsets, etc.). Consequently, each of clients 506a-506i may behave very differently in the wireless network from both radio frequency (RF) and traffic perspectives. In addition, while office environment 500 is shown as comprising a wireless network, it should be appreciated that it may also include one or more wired networks, as well (e.g., an Ethernet-based network, etc.).

As noted above, application QoE is a key priority in many enterprise networks, with a strong desire to monitor and understand the drivers behind good or bad QoE, as well as taking actions to improve user satisfaction when it may be lacking. To this end, SDN solutions, such as Cisco's DNA Center, allow for the collection of detailed network telemetry (e.g., RSSI, SNR, loss, latency, jitter, etc.) that can be used to infer user QoE using either simple heuristics or formulas, in accordance with the techniques above. For instance, such a system may compute a QoE score or a Mean Opinion Score (MOS) as defined by the International Telecommunications Union (ITU). More sophisticated approaches, such as cognitive networks, can leverage machine learning models that can be trained to infer QoE based on both application and network metrics.

Office environments, such as office environment 500, also present various conditions that can also affect the QoE of an application. However, one observation herein is that, in recent years, smart buildings solutions, such as Cisco's DNA Spaces, have become increasingly popular in enterprises. In general, they leverage telemetry from an array of devices such as sensors, smart cameras, IoT devices, access points, and network switches, to facilitate the real-time monitoring of indoor environmental conditions (noise, temperature, humidity) and occupancy levels in an office environment. These solutions provide access to a new set of key performance indicators (KPIs) which can be used to better infer the QoE of an application from the perspective of its users and were previously not considered, as they were historically difficult or impossible to monitor.

### Physical Space Recommendations to Optimize User Application QoE in Office Environments

The techniques herein introduce a recommendation system that leverages both network telemetry (e.g., as collected by SDN controllers) and environmental data collected by smart building solutions, to forecast user satisfaction with their experience when accessing a given online application. In turn, the system can proactively provide recommendations which can be acted on by individual users to increase the overall QoE when located in office environments. For instance, the output of the system can take the form of recommendations such as:
“For your Video call at 13:00, we recommend that you move to Room-A where wireless performance will be much better.”
“The ambient noise levels in your current area are expected to increase between 12:00 and 14:00. Here is a list of alternate spaces in your building with similar or better network coverage and lower noise levels for that period.”
“Wireless performance is this area is expected to drop between 16:00 and 18:00. Here is a list of alternate spaces in your building where performance will be unaffected.”

In contrast to predictive routing systems, where recommendations focus on changes at the network level (e.g., reroute traffic on alternate circuits), the system introduced herein focuses on proactive actions that can be taken by, and for, users to increase their QoE. Given that hybrid work practices have become common place in most enterprise environments, where most users visit the office a few times per week and work from shared spaces or hot desks, these types of user recommendations are expected to become increasingly useful.

As would be appreciated, the term “office environment” is intended to be viewed as inclusive of any type of working environment for users and not limited to simply corporate buildings. For instance, other examples of office environments may include, but are not limited to, government buildings, school or college buildings, non-profit and other organizations, coworking spaces, or the like.

Illustratively, the techniques described herein may be performed by hardware, software, and/or firmware, such as in accordance with application experience optimization process 248, which may include computer executable instructions executed by the processor 220 (or independent processor of interfaces 210) to perform functions relating to the techniques described herein.

Specifically, according to various embodiments, a device obtains network telemetry and environmental telemetry associated with a physical environment. The device forecasts, based on the network telemetry and environmental telemetry, future values of the network telemetry and environmental telemetry. The device predicts, based on the future values, quality of experience metrics for an online application for different locations within the physical environment. The device provides, based on the quality of experience metrics, a recommendation to a user interface that recommends a user of the online application navigate to a particular location from among the different locations to access the online application at a future point in time.

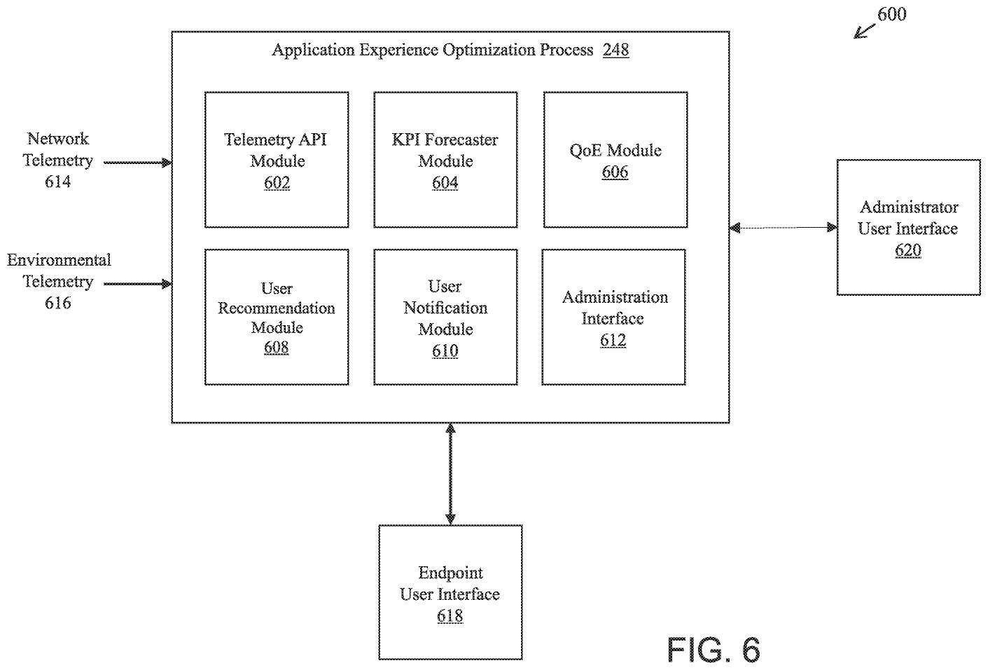

Operationally, FIG. 6 illustrates an example architecture 600 for providing physical space recommendations to optimize user application quality of experience (QoE) in office environments, according to various embodiments. At the core of architecture 600 is application experience optimization process 248, which may be executed by a controller for a network or another device in communication therewith. For instance, application experience optimization process 248 may be executed by a controller for a network (e.g., SDN controller 408 in FIGS. 4A-4B, such as part of predictive application aware routing engine 412, WLC 512 or service 514 in FIG. 5, or another supervisory device), a particular networking device in the network (e.g., a router, a firewall, etc.), a server, another device or service in communication therewith, or the like.

As shown, application experience optimization process 248 may include any or all of the following components: a telemetry API module 602, a KPI forecaster module 604, a QoE module 606, a user recommendation module 608, a user notification module 610, and/or an administration interface 612. As would be appreciated, the functionalities of these components may be combined or omitted, as desired. In addition, these components may be implemented on a singular device or in a distributed manner, in which case the combination of executing devices can be viewed as their own singular device for purposes of executing application experience optimization process 248.

During execution, telemetry API module 602 may be responsible for collecting network telemetry 614 and environmental telemetry 616 from existing controllers or systems. For instance, network telemetry 614 may include, but is not limited to, any or all of the following types of information:
Network telemetry from a network controller, such as an SDN controller (e.g., from DNAC/Meraki or a similar such controller).
Wireless Metrics: signal-to-noise (SNR), received signal strength indicator (RSSI), channel width, channel load, interference, etc.
Device type and configuration (e.g., the type and configuration of the endpoint accessing the online application)
Performance data such as loss, latency, or jitter
Interface statistics such as bandwidth usage or error counters
System performance information such as memory or CPU load
Network services KPIs: e.g., 802.1X Authentication times, DNS resolution statistics, etc.
User statistics: e.g., active users on each device, applications used by each user, per user bandwidth consumption, etc.

In addition, environmental telemetry 616 may include any or all of the following types of information, among others:
Physical layout information: floor plans, the position of each room in an office environment, room names and designations (e.g., meeting room, canteen, elevator, hallway, shared space), the capabilities of each room (e.g., audio/video equipment, screens, projectors, etc.).
Network equipment placement information: the location of each wireless access point or network port in the physical environment.
Environmental KPIs: ambient noise levels, humidity, temperature, etc.
Occupancy levels: the number of people in each room/space in the building, on the floor, etc.

In some implementations, telemetry API module 602 may also integrate with collaboration and calendaring tools in use in the enterprise such as Webex Teams, Zoom, Microsoft Teams, and the like, and periodically queries them for information such as the following:
Schedule and availability of each meeting room in the building
Planned meetings for each user in the building
Etc.

In various embodiments, KPI forecaster module 604 may be responsible for forecasting the evolution of the various network and environmental KPIs into the future, based on the telemetry collected by telemetry API module 602. To do so, KPI forecaster module 604 may leverage any number of suitable timeseries forecasting tools such as autoregressive integrated moving average (ARIMA), Prophet, or more sophisticated machine learning techniques such as Gradient Boosting Trees (GBTs) or Long Short-Term Memory (LSTM), to name a few. KPI forecaster module 604 forecasts each network and environmental KPI into the future (e.g., several hours in advance) and makes the data available to the downstream components of application experience optimization process 248, as detailed below.

Note that the model used by KPI forecaster module 604 may also leverage exogeneous variables, such as the corporate calendar (e.g., all-hands meetings, customer meetings, etc.), workplace management data (e.g., construction work, maintenance), etc., to predict more accurately key drivers of the user experience/application QoE, such as the ambient noise or the RSSI of various APs at a given location.

QoE module 606 may take as input the forecasted KPI timeseries produced by the KPI forecaster module 604, as well as the user scheduling information and/or meeting room availability, to predict the application QoE.

In one embodiment, QoE module 606 may focus on improving the user experience for voice and video applications, while users of those applications are in the office. In this case, QoE module 606 may make use of the scheduling information collected by telemetry API module 602 and determine which users have upcoming voice or video events. In turn, QoE module 606 may then infer the expected QoE scores for each upcoming event from all potential spaces or rooms in the building which are available during that meeting interval.

In one implementation, QoE module 606 may infer QoE scores for voice and video applications based on simple heuristics where the forecasted network performance and environmental APIs in each potential space/location are compared against statically defined thresholds, e.g.: latency <100 ms, loss <1%, jitter <50 ms, ambient noise <dB, space occupancy <low, etc. In another implementation, QoE module 606 may use a more sophisticated pre-trained machine learning model to infer the expected QoE scores.

In another embodiment, QoE module 606 may take a more generalized approach where, in addition to voice and video, QoE scores may be inferred for other applications each with on its own static SLA profile or dedicated QoE model. In addition, KPI forecaster module 604 can also forecast application usage based on historical usage patterns for each user, which QoE module 606 may use to predict the QoE at any given time.

User recommendation module 608 may take as input the QoE scores provided by QoE module 606 and is responsible for producing recommendations that can be used to improve the user experience. To do so, user recommendation module 608 may compare the expected QoE score for the current location of a user with the QoE score expected in all other potential spaces in the building or in neighboring building for a particular future time interval (e.g., next hour, next time interval with voice or video calls. If one or more alternate spaces can provide a significant improvement in either network or/and environmental conditions, user recommendation module 608 may issue a corresponding recommendation. When applicable, user recommendation module 608 may also query a room reservation system to only consider rooms that would be available during the target time interval, to avoid recommending that a user move to a space that has already been booked to maximum capacity. In yet another embodiment, user recommendation module 608 may decide to move other meetings, in order to accommodate that meeting. For instance, user recommendation module 608 may move another meeting scheduled for X participants in room A to room B if capacity(roomB)>X and only room A has enough room for the meeting.

A recommendation by user recommendation module 608 may also notify a user of an upcoming network (e.g.: AP capacity issues) or environmental degradation event (e.g.: noise increase) and provide alternate spaces in the building that a user may move to in order maintain or improve user experience. For example, user recommendation module 608 may issue recommendations such as the following:
“For your Video call at 13:00, we recommend you move to Room-A where wireless performance is much better.”
“The noise levels in your current area are expected to increase between 12:00 and 14:00. Here is a list of alternate spaces in your building with similar or better network coverage and lower noise levels for that period.”
“Wireless performance is this area is expected to drop between 16:00 and 18:00. Here is a list of alternate spaces in your building where performance will be unaffected.”

Additionally, user recommendation module 608 may leverage an API interface to query wayfinding services provided by the smart building controller and include instructions in its recommendation regarding the easiest or shortest path by which a user can reach the proposed space/room based on their current location.

In some instances, an administrator may provide constrains to user recommendation module 608 via an administrator user interface 620 such that undesired behavior is avoided. For example, the administrator may specify constrains around the maximum percentage of users that should be redirected to new areas in any interval of time so as not to overload a particular space with new users.

During execution, user notification module 610 may be responsible for communicating a recommendation produced by user recommendation module 608 to an end user via an endpoint user interface 618. To do so, user notification module 610 may leverage a chat bot which interacts with the user over a collaboration application, by utilizing a dedicated agent on the user device, or via another notification mechanism (e.g., text message, email, etc.).

In some instances, user notification module 610 may also provide an interface for the user to request on-demand recommendations from the system. For example, a user that needs to perform an important task may query the system for locations in the building with lower noise for the next hour. In another example, a user that may need to urgently download a large file may query the system for locations with better wireless performance.

In various embodiments, administration interface 612 may interact with administrator user interface 620 to allow a system administrator to inspect the output of the system, such as the recommendations produced by user recommendation module 608, their acceptance rate, performance metrics, or any feedback provided by each user. In addition, as noted above, administration interface 612 may also allow the administrator to specify system configurations or constrains, as well.

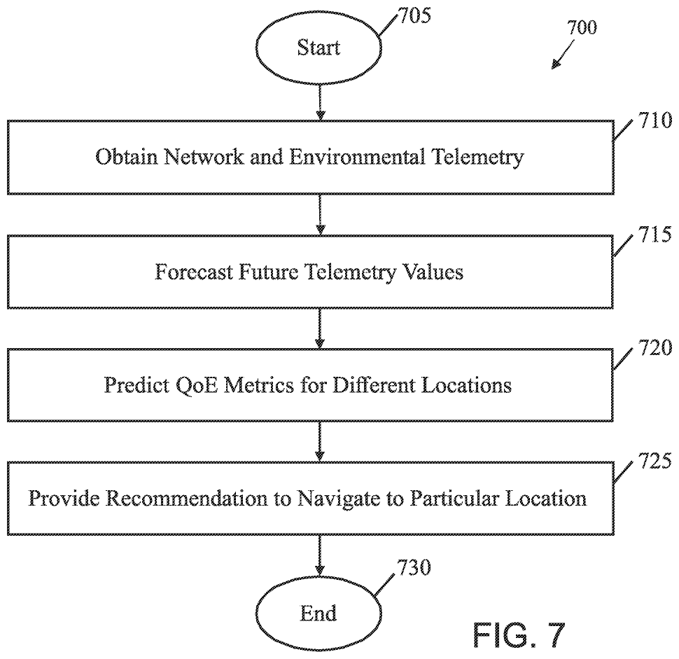

FIG. 7 illustrates an example simplified procedure 700 (e.g., a method) for providing physical space recommendations to optimize user application QoE in office environments, in accordance with one or more embodiments described herein. For example, a non-generic, specifically configured device (e.g., device 200), such as a router, firewall, controller for a network (e.g., an SDN controller, a wireless controller, or other device in communication therewith), server, or the like, may perform procedure 700 by executing stored instructions (e.g., application experience optimization process 248). The procedure 700 may start at step 705, and continues to step 710, where, as described in greater detail above, the device may obtain network telemetry and environmental telemetry associated with a physical environment. In some implementations, the environmental telemetry comprises at least one of: an ambient noise level or an occupancy level. In a further implementation, the environmental telemetry comprises sensor data from a sensor that measures a physical characteristic of the physical environment. In another implementation, the network telemetry comprises wireless metrics. In some cases, the device obtains the network telemetry and the environmental telemetry from a software-defined networking controller.

At step 715, as detailed above, the device may forecast, based on the network telemetry and environmental telemetry, future values of the network telemetry and environmental telemetry. For instance, the device may use an ARIMA model, LSTM model, GBT, or any suitable model capable of forecasting timeseries.

At step 720, the device may predict, based on the future values, quality of experience metrics for an online application for different locations within the physical environment, as described in greater detail above. In various implementations, the device may do so by using the future values as input to a quality of experience prediction model trained to predict the quality of experience of an online application. In some cases, the prediction model may be trained at least in part using feedback from users of the application regarding their satisfaction with the application, MOS scores, or other application-related information. In some implementations, the online application is a videoconferencing application.

At step 725, as detailed above, the device may provide, based on the quality of experience metrics, a recommendation to a user interface that recommends a user of the online application navigate to a particular location from among the different locations to access the online application at a future point in time. In various instances, the recommendation indicates an upcoming network or environmental degradation to the quality of experience of the online application. In some implementations, the device may also reserve use of the particular location by the user during the future point in time via a meeting scheduling system. In such a case, in some instances, the device may further cause the meeting scheduling system to move a meeting at the future point in time from the particular location to another location in the physical environment. In another implementation, the recommendation includes navigation instructions to navigate the user to the particular location, based on a floor plan for the physical environment.

Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for physical space recommendations to optimize user application QoE in office environments, it is to be understood that various other adaptations and modifications may be made within the spirit and scope of the embodiments herein. For example, while certain embodiments are described herein with respect to using certain models for purposes of predicting application experience metrics (e.g., QoE metrics), SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, network telemetry and environmental telemetry associated with a physical environment;
forecasting, by the device and based on the network telemetry and environmental telemetry, future values of the network telemetry and environmental telemetry;
predicting, by the device and based on the future values, quality of experience metrics for an online application for different locations within the physical environment; and
providing, by the device and based on the quality of experience metrics, a recommendation to a user interface that recommends a user of the online application navigate to a particular location from among the different locations to access the online application at a future point in time.

2. The method as in claim 1, wherein the environmental telemetry comprises at least one of: an ambient noise level or an occupancy level.

3. The method as in claim 1, wherein the environmental telemetry comprises sensor data from a sensor that measures a physical characteristic of the physical environment.

4. The method as in claim 1, wherein the recommendation indicates an upcoming network or environmental degradation to the quality of experience of the online application.

5. The method as in claim 1, further comprising:
reserving, by the device, use of the particular location by the user during the future point in time via a meeting scheduling system.

6. The method as in claim 5, further comprising:
causing, by the device, the meeting scheduling system to move a scheduled meeting at the future point in time from the particular location to another location in the physical environment to accommodate the user of the online application at the particular location instead.

7. The method as in claim 1, wherein the recommendation includes navigation instructions to navigate the user to the particular location, based on a floor plan for the physical environment.

8. The method as in claim 1, wherein the network telemetry comprises wireless metrics.

9. The method as in claim 1, wherein the device obtains the network telemetry and the environmental telemetry from a software-defined networking controller.

10. The method as in claim 1, further comprising:
selecting the particular location from among the different locations for recommendation to the user based on user redirection constraints associated with network load allocations.

11. An apparatus, comprising:
one or more network interfaces;
a processor coupled to the one or more network interfaces and configured to execute one or more processes; and
a memory configured to store a process that is executable by the processor, the process when executed configured to:
obtain network telemetry and environmental telemetry associated with a physical environment;
forecast, based on the network telemetry and environmental telemetry, future values of the network telemetry and environmental telemetry;
predict, based on the future values, quality of experience metrics for an online application for different locations within the physical environment; and
provide, based on the quality of experience metrics, a recommendation to a user interface that recommends a user of the online application navigate to a particular location from among the different locations to access the online application at a future point in time.

12. The apparatus as in claim 11, wherein the environmental telemetry comprises at least one of: an ambient noise level or an occupancy level.

13. The apparatus as in claim 11, wherein the environmental telemetry comprises sensor data from a sensor that measures a physical characteristic of the physical environment.

14. The apparatus as in claim 11, wherein the recommendation indicates an upcoming network or environmental degradation to the quality of experience of the online application.

15. The apparatus as in claim 11, wherein the process when executed is further configured to:
reserve use of the particular location by the user during the future point in time via a meeting scheduling system.

16. The apparatus as in claim 15, wherein the process when executed is further configured to:
cause the meeting scheduling system to move a meeting at the future point in time from the particular location to another location in the physical environment.

17. The apparatus as in claim 11, wherein the recommendation includes navigation instructions to navigate the user to the particular location, based on a floor plan for the physical environment.

18. The apparatus as in claim 11, wherein the network telemetry comprises wireless metrics and the apparatus obtains the network telemetry and the environmental telemetry from a software-defined networking controller.

19. The apparatus as in claim 11, wherein the process when executed is further configured to:
select the particular location from among the different locations for recommendation to the user based on a user capacity associated with the particular location at the future point in time.

20. A tangible, non-transitory, computer-readable medium storing program instructions that cause a device to execute a process comprising:
obtaining, by the device, network telemetry and environmental telemetry associated with a physical environment;
forecasting, by the device and based on the network telemetry and environmental telemetry, future values of the network telemetry and environmental telemetry;
predicting, by the device and based on the future values, quality of experience metrics for an online application for different locations within the physical environment; and
providing, by the device and based on the quality of experience metrics, a recommendation to a user interface that recommends a user of the online application navigate to a particular location from among the different locations to access the online application at a future point in time.
